(19) United States
(12) Patent Application Publication
(10) Pub. No.: US 2002/0020077 A1
(43) Pub. Date: Feb. 21, 2002

(54) Blowing apparatus

(76) Inventors: Kazuhiro Haraga, Fukuoka (JP); Yoshihito Yonezawa, Fukuoka (JP); Mitsuo Rikimaru, Fukuoka (JP); Ryosuke Kato, Fukuoka (JP); Yoshihiro Ogami, Fukuoka (JP)

Correspondence Address: Michael D. Bednarek, SHAWPITTMAN, 2300 N Street, N.W., Washington, DC, 20037, US

(21) Appl. No.: 09/928,310

(22) Filed: Aug. 14, 2001

(30) Foreign Application Priority Data
Aug. 15, 2000 (JP) 2000-225073

(51) Int. Cl. F26B 17/00

(52) U.S. Cl. 34/576

(57) ABSTRACT

According to the present invention, a blowing apparatus A comprises a water receiving portion 1 which is provided in an opening 3 of a counter D, an air supplying means 5 which is provided in the internal space of the counter D and comprised of a blower 5a or the like for supplying high-velocity air, an air projecting port 6 which is connected to the air supplying means 5 and provided in the front side of the counter D so as to project high-velocity air in a direction not toward a user, and a water spout port 4 for spouting water toward the water receiving portion 1 which is provided in the counter D. With this structure, a blowing apparatus can be provided which solves the problems that clothes or the like of a user are wet or air is directed or redirected onto the face of a user and whereby annoyance or discomfort is caused to the user.

### BACKGROUND OF THE INVENTION

1. Field of the Invention

The present invention relates to a blowing apparatus for drying hands by blowing water or the like which adheres to the hands with air.

2. Description of the Prior Art

In the conventional art as described, for example, in Japanese Unexamined Patent Application Publication Sho 61-122823, is known an apparatus for drying hands.

In a device according to such a conventional art, hands are washed by putting the hands below a washing nozzle 7 and dried by putting the hands below a high-pressure air nozzle 18 and blowing water drops, which adhere to the hands, off of the hands with high-pressure air projected from the high-pressure air nozzle 18.

However, in the conventional art of the above-mentioned structure, since the high-pressure air is projected downwards for directing to the hands, water drops which adhere to the hands or adhere to a receiving portion of the device provided below the hands, are scattered, such that the scattered water drops wet the clothes or the like of a user. Also, a part of the high-pressure air which is not projected onto the hands is deflected by the receiving portion, and this deflected air is passes to the face or the like of a user and thereby causes annoyance or discomfort on the part of the user.

In addition, since the washing nozzle 7 and the high-pressure air nozzle 18 are provided adjacent to each other, washing water spouted from the washing nozzle 7 is scattered by the hands and the scattered water enters the high-pressure nozzle 18. This scattered water entering the nozzle 18 may cause a problem such as damage to the internal components.

Therefore, the first purpose of the present invention is to provide a blowing apparatus for solving the problems that water is scattered upon the clothes or the like of a user or air is directed or redirected onto the face or the like of a user and thereby annoyance or discomfort is caused on the part of the user.

Also, the second purpose of the present invention is to provide a blowing apparatus for preventing scattered water from entering the internal components thereof and thereby preventing any resultant problems including damage to internal components.

### SUMMARY OF THE INVENTION

According to the first aspect of the present invention, there is provided a blowing apparatus comprising an air projecting port for projecting air to blow water or the like which adheres to hands and a water receiving portion for receiving the blown water or the like, wherein the water receiving portion is provided below the hands which are put toward the air projecting port and the air projecting port projects air in a direction not toward a user and in a substantially horizontal direction or an upward direction.

With this structure, since the air for blowing water or the like which adheres to hands is projected in a direction not toward a user and in a substantially horizontal direction or an upward direction, it is possible to prevent the blown water or the like from wetting clothes or the like of a user It is also possible to prevent the projected air from being redirected from the water receiving portion, so as to prevent any annoyance or discomfort of a user that may be caused by air directed or redirected onto the face or the like of the user.

According to the present invention, there is also provided a blowing apparatus comprising a water spout port, an air projecting port for projecting air to blow water or the like which adheres to hands and a water receiving portion for receiving the blown water or the like and water which is spouted from the water spout port, wherein the air projecting port projects air in a direction not toward a user. With this structure, since air is projected in a direction not toward a user, it is possible to prevent the blown water or the like from wetting clothes or the like of a user.

In addition, in a case where the air projecting port projects air in a substantially horizontal direction or an upward direction, it is possible to prevent the projected air from rebounding from the water receiving portion, so as to prevent annoyance or discomfort of a user that may be caused by air directed or redirected onto the face or the like of the user.

According to the present invention, there is also provided a blowing apparatus comprising an air projecting port for projecting air to blow water or the like which adheres to hands, a water receiving portion for receiving the blown water or the like and an air aspirating port for aspirating the air which is projected from the air projecting port. With this structure, since the air which is projected from the air projecting port is aspirated through the air aspirating port, it is possible to prevent the projected air from flowing to the outside of the water receiving portion, so as to prevent annoyance or discomfort of a user or a person near to the user that may be caused by air directed or redirected onto the face or the like thereof.

In addition, in a case where the air projecting port projects air in a substantially horizontal direction or a downward direction toward the water receiving portion, it is possible to aspirate the projected air from the air projecting port after the air is filled into the water receiving portion, so as to surely prevent the projected air from flowing to the outside of the water receiving portion and surely prevent annoyance or discomfort on the part of a user or a person near to the user that may be caused by air directed or redirected onto the face or the like thereof.

In a case where the air aspirating port is provided in the position opposite to the air projecting port in the water receiving portion, since the air projected from the air projecting port can more surely be aspirated through the air aspirating port, it is possible to more surely prevent the projected air from flowing to the outside of the water receiving portion and more surely prevent annoyance or discomfort of a user itself or a person near to the user that may be caused by air directed or redirected onto the face or the like thereof.

In a case where a scattered water preventing portion for preventing water or the like which adheres to the water receiving portion from scattering to the outside of the water receiving portion is formed so as to extend toward the inside of the water receiving portion in the position opposite to the air projecting port in the water receiving portion, even if the air projected from the air projecting port is directed upon water or the like so as to scatter the water or the like, it is possible to prevent the scattered water from being propelled to the outside of the water receiving portion.

In a case where an air supplying means for supplying air to the air projecting port is provided, in which the air supplying means is combined with functions such as those of an air aspirating means for aspirating the air aspirated through the air aspirating port, it is not necessary to provide such an air aspirating means. As a result of this, it is possible to reduce the number of the components and thereby a blowing apparatus having a simple structure can be provided.

According to the present invention, there is also provided a blowing apparatus comprising a water spout port, an air projecting port for projecting air to blow water or the like which adheres to hands and a water receiving portion for receiving the blown water or the like and water which is spouted from the water spout port, wherein the water receiving portion is located below the hands that are put toward the air projecting port and the air projecting port projects air in a direction not toward a user and in a substantially horizontal direction or an upward direction at an air velocity of 30 m/second or more. With this structure, although air is projected at a high velocity, it is still possible to prevent the blown water or the like from wetting clothes or the like of a user, and to prevent the projected air from rebounding from the water receiving portion, so as to prevent annoyance or discomfort of a user that may be caused by air directed or redirected onto the face or the like of the user.

According to the second aspect of the present invention, there is provided a blowing apparatus comprising a water spout port, an air projecting port for projecting air to blow water or the like which adheres to hands, a water receiving portion for receiving the blown water or the like and water which is spouted from the water spout port, a drain port for draining the blown water or the like and the spouted water, and a deflecting means, for deflecting the direction of the air projected from the air projecting port to the direction of leaving the drain port, which is provided between the air projecting port and the drain port.

With this structure, the air projected from the air projecting port is not directed upon any water or the like, having been blown or having been spouted from the water spout port, staying in the vicinity of the drain port. As a result of this, it is possible to prevent the fouling of a counter or the like outside of the water receiving portion that may be caused by the scattering of the water staying in the vicinity of the drain port.

In a case where the deflecting means is comprised of a partition wall for separating the water receiving portion into two parts respectively for receiving the water spouted from the water spout port and for receiving the blown water or the like, it is possible to perform the above-mentioned effect with a simple structure.

In addition, in a case where a drain port is provided in each of the two separated parts in the water receiving portion and the air which is projected from the air projecting port is aspirated through the drain port in the part for receiving the blown water or the like, besides the above-mentioned effect, it is also possible to prevent the projected air from flowing to the outside of the water receiving portion and thereby prevent annoyance or discomfort of a user or a person near the user that may be caused by air directed or redirected onto the face or the like thereof.

According to the third aspect of the present invention, there is provided a blowing apparatus comprising a water spout port, an air projecting port for projecting air to blow water or the like which adheres to hands, a water receiving portion for receiving the blown water or the like and water which is spouted from the water spout port, and a deflecting means, which is provided between the air projecting port and the water spout port, for deflecting any water scattered by the water spouted from the water spout port to the direction of the air projecting port.

With this structure, it is possible to prevent any water that may be scattered by the water spouted from the water spout port from entering the internal components and thereby prevents any resultant problem such as damage to the internal components.

Further, in a case where the deflecting means is comprised of a barrier wall for blocking the scattered water scattered by the water spouted from the water spout port, it is possible to reliably perform the above-mentioned effect with a simple structure.

### BRIEF DESCRIPTION OF THE DRAWINGS

FIG. 1 is a plan view of the first embodiment of a blowing apparatus according to the present invention;

FIG. 2 is a schematic cross-sectional view of the first embodiment of a blowing apparatus according to the present invention;

FIG. 3 is a plan view of the second embodiment of a blowing apparatus according to the present invention;

FIG. 4 is a schematic cross-sectional view of the second embodiment of a blowing apparatus according to the present invention;

FIG. 5 is a plan view of the third embodiment of a blowing apparatus according to the present invention;

FIG. 6 is a schematic cross-sectional view taken along line X-X of FIG. 5; and

FIG. 7 is a schematic cross-sectional view taken along line Y-Y of FIG. 5.

### DETAILED DESCRIPTION OF THE PREFERRED EMBODIMENTS

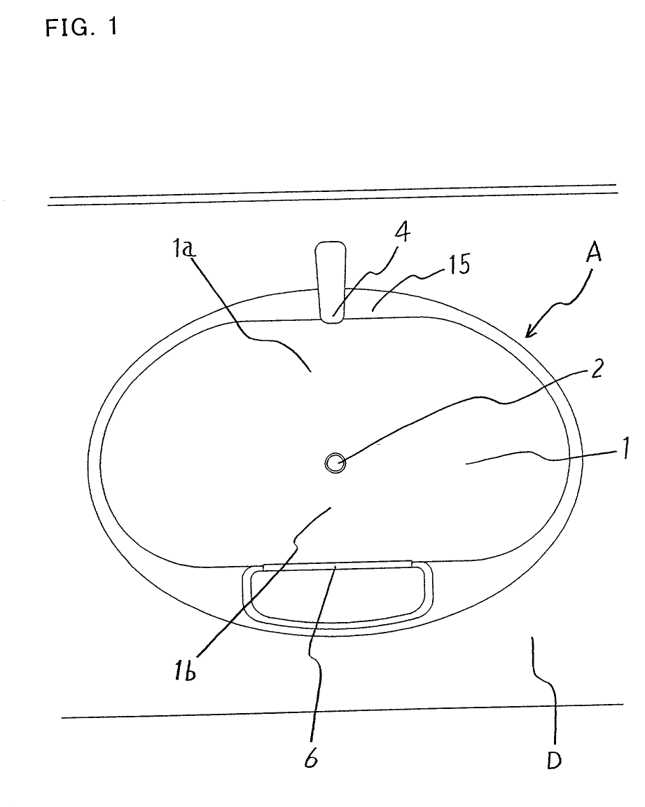

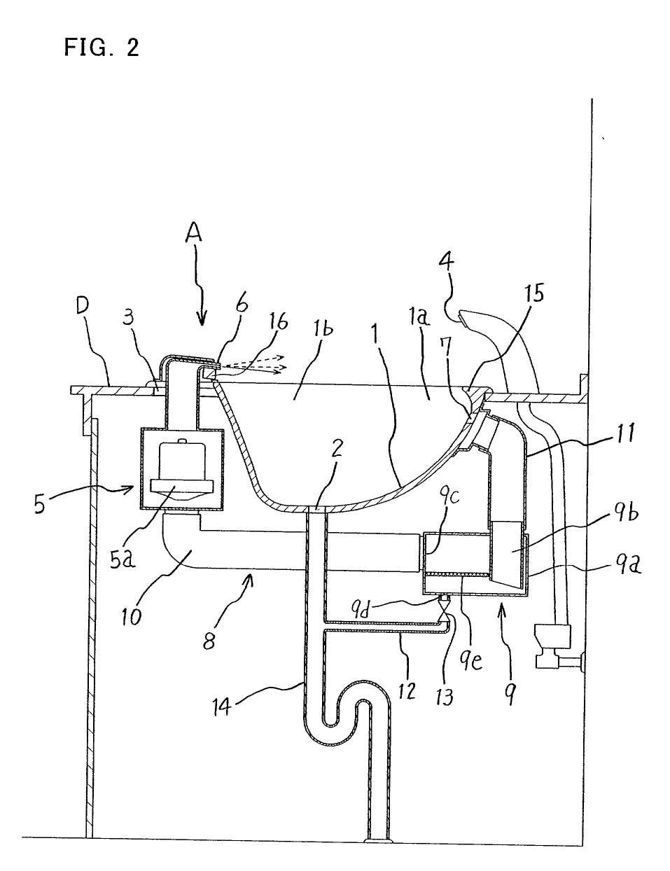

Preferred embodiments of the present invention will now be described with reference to the accompanying drawings. FIG. 1 is a plan view of the first embodiment of a blowing apparatus according to the present invention and FIG. 2 is a schematic cross-sectional view of the first embodiment of a blowing apparatus according to the present invention.

As shown in FIGS. 1 and 2, a blowing apparatus A, which is incorporated into a counter D, comprises a water receiving portion 1 which is provided in an opening 3 of the counter D, an air supplying means 5 which is provided in the internal space of the counter D comprised of a blower 5a or the like for supplying high-velocity air, an air projecting port 6 which is connected to the air supplying means 5 and provided in the front side of the counter D so as to project air in a direction of leaving a user at an air velocity of 30 m/second or more, and a water spout port 4 for spouting water toward the water receiving portion 1 which is provided in the counter D.

A drain port 2 is provided in the bottom of the water receiving portion 1 and an air aspirating port 7 is provided above the position opposite to the air projecting port 6. A drain passage 14 is connected to the drain port 2 and a circulating passage 8 is connected to the air aspirating port 7.

The air aspirating port 7 is for aspirating the air which is projected from the air projecting port 6 or the water or the like which is blown from hands with the projected air. The circulating passage 8, which is connected to the air supplying means 5, is comprised of an air-water separating means 9 for separating the air and the water or the like which is aspirated through the air aspirating port 7, an air aspirating pipe 10 for sending air which is separated in the air-water separating means 9 to the air supplying means 5, and a drain pipe 11 for sending the air and the water or the like aspirated through the air aspirating port 7 to the air-water separating means 9.

The air-water separating means 9 is comprised of a body 9a, a flowing pipe 9b which is inserted into the body 9a, an air drain port 9c which is connected to the air aspirating pipe 10, a water drain port 9d which is provided in the bottom of the body 9a, and a sheet member 9e positioned between the air drain port 9c and the water drain port 9d and having a number of pores, comprised of a punched metal sheet or the like.

A water drain passage 12 for draining the separated water or the like is connected to the water drain port 9d. The water drain passage 12 is also connected to a drain passage 14 which is connected to the water receiving portion 1. Further, an open-closed valve 13 is provided in the water drain passage 12 and the valve 13 is closed corresponding to the driving of the air supplying means 5.

A scattered water preventing portion 15 is provided so as to extend toward the inside of the water receiving portion 1 at the upper periphery of the position opposite to the air projecting port 6 in the water receiving portion 1. The scattered water preventing portion 15 prevents the water or the like which is blown with the air projected from the air projecting port 6 from scattering onto the counter D so as to prevent the fouling of the counter D.

Hereinafter, the operation of the blowing apparatus A having the above-mentioned structure will be described.

When an user puts the hands toward the water spout port 4, the presence of the hands is detected by a hand detecting sensor (not shown) which is installed within the water spout port 4 and thereby the spouting of the water from water spout port 4 is triggered. The user can wash the hands within a hand washing region 1a with this water.

After the user finishes washing the hands, by moving the hands toward the air projecting port 6, the hand detecting sensor stops detecting the hands and thereby spouting of water from the water spout port 4 is stopped. Next, another hand detecting sensor 16 which is provided in the vicinity of the air projecting port 6 detects the presence of the hands. The signal of the detection controls the air supplying means 5, high-velocity air is projected from the air projecting port 6 toward the upper portion of the water receiving portion 1 in the direction shown by the solid line arrow in FIG. 2, and the hands are dried by the high-velocity air projected to blow water or the like which adheres to the hands in a drying region 1b.

A part of the high-velocity air projected from the air projecting port 6 is directed against the water receiving portion 1 and fills the water receiving portion 1. However, the filling air is aspirated into the air aspirating port 7 and through the circulating passage 8 to the air supplying means 5. Therefore, it is possible to prevent the air projected toward the upper portion of the water receiving potion 1 from flowing to the outside of the water receiving portion 1 and to prevent the air from redirecting onto a user or the like, and thereby discomfort or annoyance of the user can be prevented.

The water or the like which is blown with the air projected from the air projecting port 6 is also aspirated from the air aspirating port 7 and thereby it is possible to prevent the water or the like from passing to the outside of the water receiving portion 1. In addition, the scattered water preventing portion 15 provided in the water receiving portion 1 can more surely prevent the water or the like from passing out.

The air and the water or the like aspirated from the air aspirating port 7 is sent into the body 9a of the air-water separating means 9 through the drain pipe 11 and the flowing pipe 9b. The velocity of the air passing through the body 9a is decreased because the cross-sectional area of the body 9a is larger than that of the flowing pipe 9b. The water or the like is settled to the bottom surface of the body 9a because of gravity.

By providing the sheet member 9e comprised of a punched metal sheet or the like between the air drain port 9c and the water drain port 9d, it is possible to prevent the water or the like from moving upwards or scattering and thereby flowing into the air drain port 9c. As a result, it is possible to surely separate the air and the water or the like. The separated air is sent to the air supplying means 5 through the air drain port 9c and the air aspirating pipe 10. The water or the like is sent to the drain passage 14 through the water drain port 9d and the water drain passage 12. Therefore, it is possible to prevent damage to the air supplying means 5 caused by the flowing of the water or the like which is aspirated from the air aspirating port 7 into the air supplying means 5. Also, the open-closed valve 13 provided in the water drain passage 12 is closed corresponding to the driving of the air supplying means 5, and thereby it is possible to prevent the aspiration of the air containing odors from the drain passage 14. Only clean air is projected from the air projecting port 6.

Air may be projected from the air projecting port 6 in a substantially horizontal direction or an upward direction as shown by the broken line arrows in FIG. 2. In such a case, if water or the like which is adheres to hands is blown, it is possible to prevent the blown water or the like from hitting a user and wetting clothes or the like of the user. Also, it is possible to prevent the projected air from being redirected outwards or back from the water receiving portion 1, so as to prevent annoyance or discomfort of a user that may be caused by air directed or redirected onto the face or the like of the user. The air aspirating port may be provided in the position opposite to the direction of the air projection, so as to aspirate the projected air.

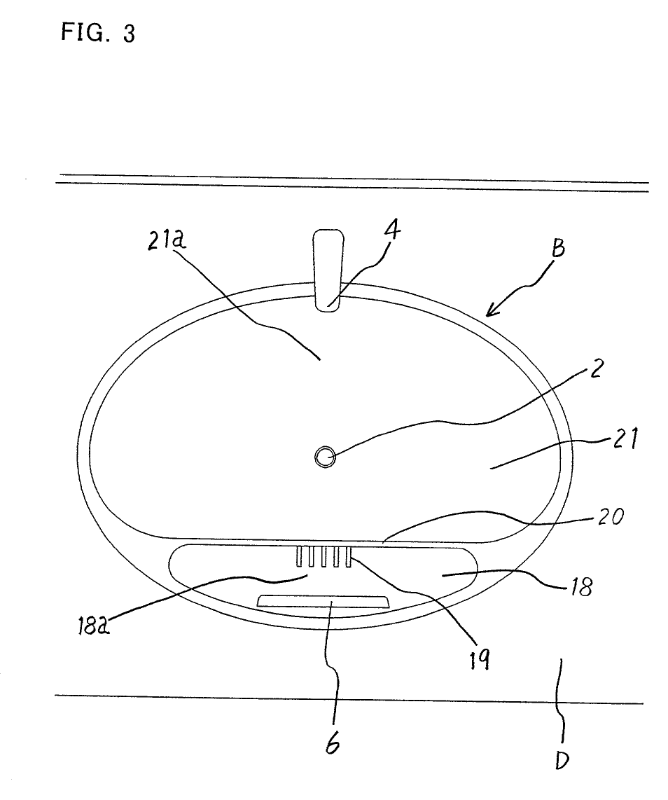

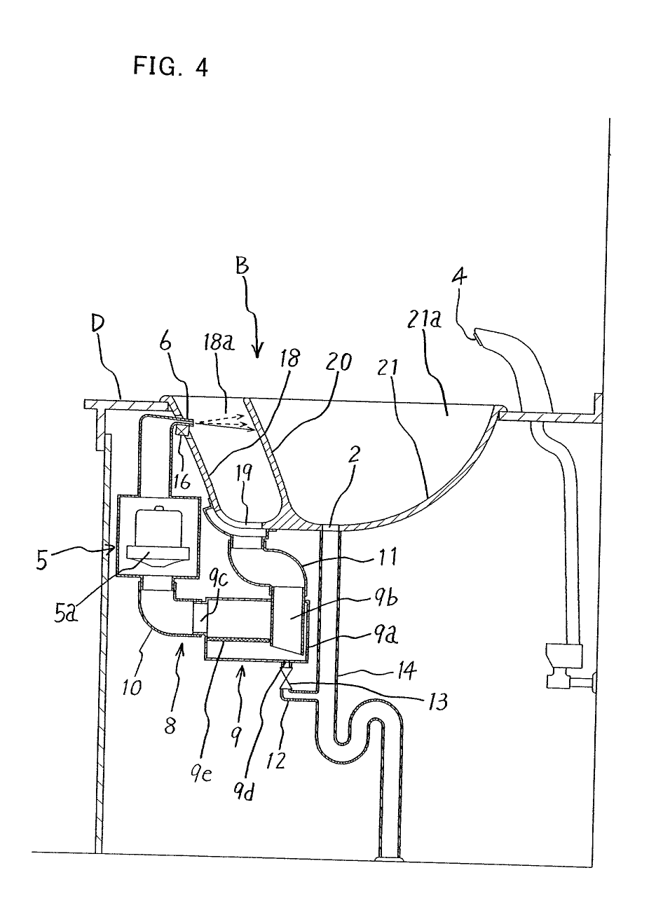

FIG. 3 is a plan view of the second embodiment of a blowing apparatus according to the present invention and FIG. 4 is a schematic cross-sectional view of the second embodiment of a blowing apparatus according to the present invention. For the same elements as those of the above-mentioned first embodiment, the same reference numbers are used, and the explanation is omitted.

As shown in FIG. 3 and FIG. 4, a blowing apparatus B is installed into a counter D in the same manner as in the first embodiment. In the blowing apparatus B, a partition wall 20 as a deflecting means is provided between an air projecting port 6 and a drain port 2, so as to separate a water receiving portion into two parts, that is, a water receiving portion 21 for receiving water which is spouted from a water spout port 4 and a water receiving portion 18 for receiving water or the like which is blown with the projected air from the air projecting port 6.

Drain ports 19 are provided at the bottom of the water receiving portion 18. The drain ports 19 are connected to an air supplying means 5 through a circulating passage 8. An air-water separating means 9 for separating the air and the water or the like which are aspirated through the drain ports 19 is provided in the circulating passage 8. The air-water separating means 9 is connected to a drain passage 14 through a water drain passage 12.

With the above-mentioned structure, in the same manner as the first embodiment, a user can wash the hands within a hand washing region 21a separated by the partition wall 20 and dry the hands by means of the high-velocity air projected to blow water or the like which adheres to the hands within a drying region 18a.

The partition wall 20 prevents the air projected from the air projecting port 6 from being directed or redirected toward the drain port 2 and thereby prevents water staying in the vicinity of the drain port 2 from scattering. As a result of this, it is possible to prevent the fouling of the counter D or the like that may be caused by scattered water.

With the provision of the partition wall 20, it is possible to prevent the interference between the water flow spouted from the water spout port 4 and the air flow projected from the air projecting port 6. As a result of this, it is possible to prevent the water flow from being blown by the air flow, so as to prevent annoyance or discomfort of a user that may be caused by scattered water hitting the user and prevent the fouling of the counter D or the like because of the scattered water.

Further, the partition wall 20 functions as a barrier wall to prevent the above-mentioned scattered water or scattered water caused by washing hands within the hand washing region 21a from entering the inside of the air projecting port 6 and thereby prevents any problem such as damage to the internal components such as the blower 5a or the like.

Furthermore, with the provision of the partition wall 20, it is possible for a user to easily visually discriminate between the hand washing region 21a and the drying region 18a. A user can use the blowing apparatus B without confusion.

Since the air projected from the air projecting port 6 and the water or the like blown with this air are aspirated through the drain ports 19 and sent to the air-water separating means 9, it is possible to prevent the air projected from the air projecting port 6 and the water or the like blown with this air from flowing to the outside of the water receiving portion 18, so as to prevent annoyance or discomfort of a user that may be caused by the scattered water scattered onto the user and prevent the fouling of the counter D or the like by the scattered water.

The partition wall 20 may be comprised of double walls, and an air aspirating port may be provided in the position opposite to the direction of the air projected from the air projecting port 6 in the partition wall 20, the air aspirating port leading to the internal space defined between the double walls of the partition wall 20. With this structure, the air projected from the air projecting port 6 may be aspirated through this air aspirating port instead of the drain port 19. In this case, it is not always necessary to provide the drain port 19. An opening leading to the water receiving portion 21 may be provided at the lower portion of the partition wall 20, so that the water or the like in the water receiving portion 18 is drained through the drain port 2.

Air may be projected from the air projecting port 6 in a substantially horizontal direction or an upward direction as shown by the broken line arrows in FIG. 4 as well as a downward direction as shown by the solid line arrow in FIG. 4. The direction in which the projected air hits on the partition wall 20 is sufficient.

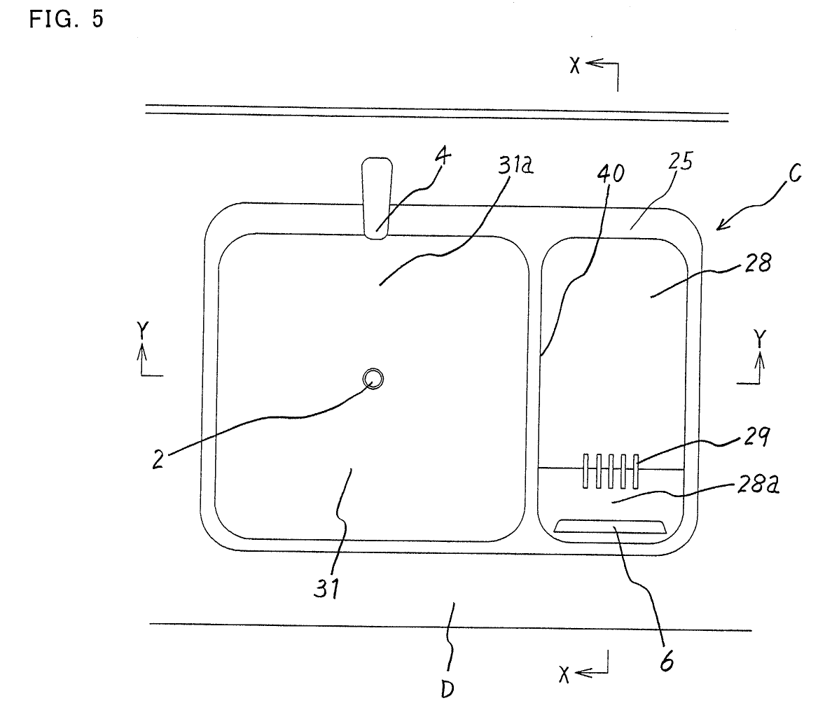

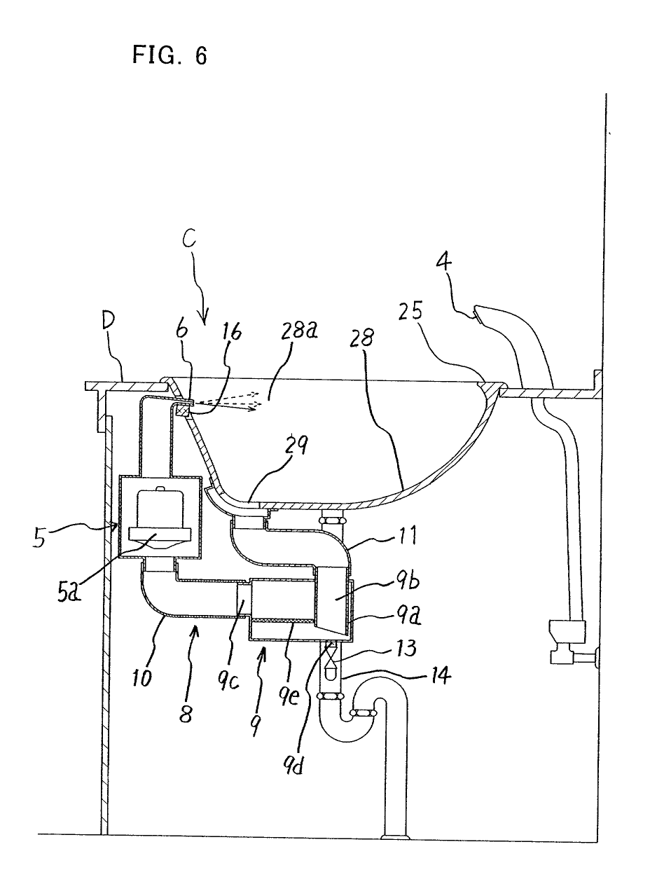

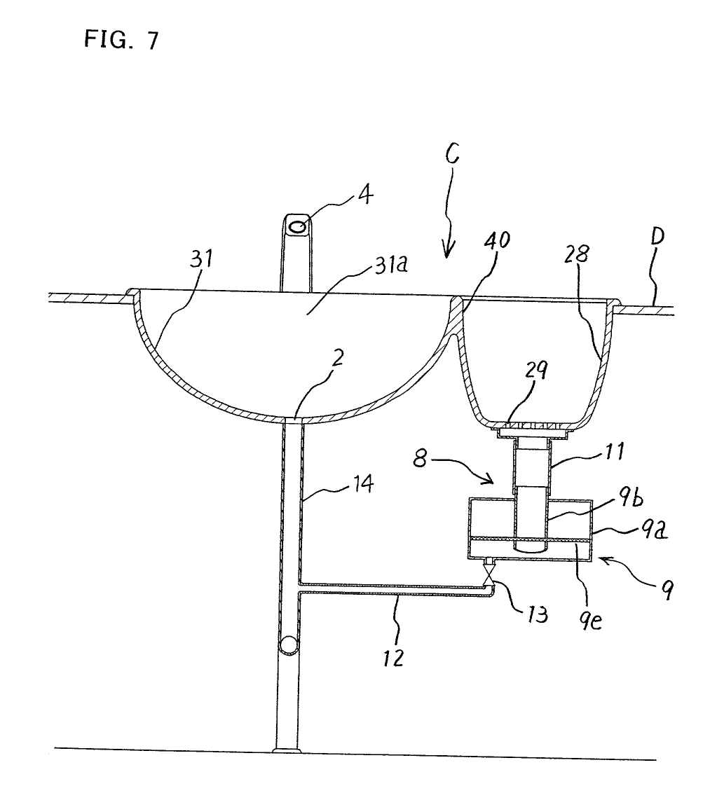

FIG. 5 is a plan view of the third embodiment of a blowing apparatus according to the present invention, FIG. 6 is a schematic cross-sectional view taken along line X-X of FIG. 5, and FIG. 7 is a schematic cross-sectional view taken along line Y-Y of FIG. 5. For the same elements as those of the above-mentioned first and second embodiments, the same reference numbers are used, and the explanation is omitted.

As shown in FIG. 5 through FIG. 7, a blowing apparatus C is installed into a counter D in the same manner as in the second embodiment. In the blowing apparatus C, a partition wall 40 as a deflecting means is provided between an air projecting port 6 and a drain port 2, so as to separate a water receiving portion into two parts, that is, a water receiving portion 31 for receiving the water which is spouted from a water spout port 4 and a water receiving portion 28 for receiving the water or the like which is blown with the projected air from the air projecting port 6.

Drain ports 29 are provided at the bottom of the water receiving portion 28 in the same manner as in the second embodiment. The drain ports 29 are connected to an air supplying means 5 through a circulating passage 8. An air-water separating means 9 for separating the air and the water or the like which are aspirated through the drain ports 29 is provided in the circulating passage 8. The air-water separating means 9 is connected to a drain passage 14 through a water drain passage 12.

A scattered water preventing portion 25 is formed so as to extend toward the inside of the water receiving portion 28 at the upper periphery of the position opposite to the air projecting port 6 in the water receiving portion 28 in the same manner as in the first embodiment, so that it is possible to prevent water or the like blown with the air projected from the air projecting port 6 from scattering onto the counter D and thereby prevent the fouling of the counter D.

The difference between the second embodiment and the third embodiment is as follows:

In the second embodiment, the partition wall 20 is provided so as to separate the water receiving portion 21 and the water receiving portion 18 in the front-to-rear direction with respect to the counter D. On the other hand, in the third embodiment, the partition wall 40 is provided so as to separate the water receiving portion 31 and the water receiving portion 28 in the fright and left direction with respect to the counter D.

With the above-mentioned structure, in the same manner as the second embodiment, a user can wash the hands within a hand washing region 31a separated by the partition wall 40 and dry the hands by blowing water or the like which adheres to the hands within a drying region 28a.

The partition wall 40 prevents the air projected from the air projecting port 6 from going to the drain port 2 and thereby prevents water staying in the vicinity of the drain port 2 from scattering. As a result of this, it is possible to prevent the fouling of the counter D or the like with scattered water.

With the provision of the partition wall 40, it is possible to prevent the interference between the water flow spouted from the water spout port 4 and the air flow projected from the air projecting port 6. As a result of this, it is possible to prevent the water flow from being blown by the air flow, so as to prevent annoyance or discomfort of a user that may be caused by the scattered water directed or redirected onto the user and prevent the fouling of the counter D or the like with the scattered water.

Further, the partition wall 40 functions as a barrier wall to prevent the water scattered by the interference between the water flow spouted from the water spout port 4 and the air flow projected from the air projecting port 6 or the water scattered by washing of hands within the hand washing region 31a from entering the inside of the air projecting port 6 and thereby prevent any problem such as water damage to the internal components such as the blower 5a or the like.

In the drawing, the height of the partition wall 40 is equal to the upper end surface of the water receiving portion 31; however, it may not be equal. It is sufficient that the partition wall 40 has a height so as to prevent the air projected from the air projecting port 6 from going to the drain port 2 and to prevent the scattered water scattered by the water spouted from the water spout port 4 from entering the air projecting port 6.

Air may be projected from the air projecting port 6 in a substantially horizontal direction or an upward direction as shown by the broken line arrows in FIG. 6 as well as a downward direction as shown by the solid line arrow in FIG. 6.

In the drawings, the water spout 4 is positioned in the left side with respect to a user and thereby the hand washing region 31a is in the left side. The air projecting port 6 is positioned in the right side with respect to a user and thereby the drying region 28a is in the right side. However, the air projecting port 6 may be positioned in the left side and the water spout port 4 may be positioned in the right side.

Further, the air projected from the air projecting port 6 and the water or the like blown with this air are aspirated through the drain port 29. However, an air aspirating port may be provided in the position opposite to the direction of the air projected from the air projecting port 6, so as to aspirate the projected air through the air aspirating port.

Furthermore, the air projecting port 6 is positioned in the front of the counter D; however, it may be positioned in the back of the counter D.

It should be noted that the above-mentioned matters refer to some preferred embodiments according to the present invention, and that the present invention is not limited to the above-mentioned matters. For example, a heating means such as a heater or the like may be provided at the upper stream of the air projecting port 6, so that warm air can be projected from the air projecting port 6.

In the above-mentioned explanation, the presence of hands is detected by a hand detecting sensor and thereby spouting of water is started. However, spouting of water may be started or stopped by opening or closing an open-closed valve by manual operation of a user.

What is claimed is:

1. A blowing apparatus comprising:
an air projecting port for projecting air to blow water or the like which adheres to hands; and
a water receiving portion for receiving the blown water or the like;
wherein said water receiving portion is provided below the hands which are positioned toward said air projecting port and said air projecting port projects air in a direction not toward a user and in a substantially horizontal direction or an upward direction.

2. A blowing apparatus comprising:
a water spout port;
an air projecting port for projecting air to blow water or the like which adheres to hands; and
a water receiving portion for receiving the blown water or the like and water which is spouted from said water spout port;
wherein said air projecting port projects air in a direction not toward a user.

3. A blowing apparatus according to claim 2, wherein said air projecting port projects air in a substantially horizontal direction or an upward direction.

4. A blowing apparatus comprising:
an air projecting port for projecting air to blow water or the like which adheres to hands;
a water receiving portion for receiving the blown water or the like; and
an air aspirating port for aspirating the air which is projected from said air projecting port.

5. A blowing apparatus according to claim 4, wherein said air projecting port projects air in a substantially horizontal direction or a downward direction toward said water receiving portion.

6. A blowing apparatus according to claim 5, wherein said air aspirating port is provided in the position opposite to said air projecting port in said water receiving portion.

7. A blowing apparatus according to claim 5, wherein a scattered water preventing portion for preventing water or the like which adheres to said water receiving portion from scattering to the outside of said water receiving portion is formed so as to extend toward the inside of said water receiving portion in the position opposite to said air projecting port in said water receiving portion.

8. A blowing apparatus according to claim 4, wherein an air supplying means for supplying air to said air projecting port is provided and said air supplying means is combined with functions as an air aspirating means for aspirating the air aspirated through said air aspirating port.

9. A blowing apparatus comprising:
a water spout port;
an air projecting port for projecting air to blow water or the like which adheres to hands; and
a water receiving portion for receiving the blown water or the like and water which is spouted from said water spout port;
wherein said water receiving portion is located below the hands when they are placed toward said air projecting port and said air projecting port projects air in a direction not toward a user and in a substantially horizontal direction or an upward direction at an air velocity of 30 m/second or more.

10. A blowing apparatus comprising:
a water spout port;
an air projecting port for projecting air to blow water or the like which adheres to hands;
a water receiving portion for receiving the blown water or the like and water which is spouted from said water spout port;
a drain port for draining the blown water or the like and the spouted water; and
a deflecting means, for deflecting the direction of the air projected from said air projecting port to the direction of leaving said drain port, which is provided between said air projecting port and said drain port.

11. A blowing apparatus according to claim 10, wherein said deflecting means is comprised of a partition wall for separating said water receiving portion into two parts respectively for receiving the water spouted from said water spout port and for receiving the blown water or the like.

12. A blowing apparatus according to claim 11, wherein a drain port is provided in each of said two separated parts in said water receiving portion and the air which is projected from said air projecting port is aspirated through the drain port in the part for receiving the blown water or the like.

13. A blowing apparatus comprising:
a water spout port;
an air projecting port for projecting air to blow water or the like which adheres to hands;
a water receiving portion for receiving the blown water or the like and water which is spouted from said water spout port; and
a deflecting means, for deflecting the direction of scattered water scattered by the water spouted from said water spout port in the direction of said air projecting port, which is provided between said air projecting port and said water spout port.

14. A blowing apparatus according to claim 13, wherein said deflecting means is comprised of a barrier wall for blocking the scattered water scattered by the water spouted from said water spout port.
